(19) United States
(12) Patent Application Publication
(10) Pub. No.: US 2002/0027584 A1
(43) Pub. Date: Mar. 7, 2002

(54) Ink-jet printer

(76) Inventors: Toshiyuki Kamanaka, Wakayama-shi (JP); Kenichi Kokusho, Wakayama-shi (JP)

Correspondence Address: WENDEROTH, LIND & PONACK, L.L.P., 2033 K Street, N.W, Suite 800, Washington, DC, 20006, US

(21) Appl. No.: 09/750,107

(22) Filed: Dec. 29, 2000

(30) Foreign Application Priority Data
Sep. 1, 2000 (JP) 2000-265555

(51) Int. Cl. B41J 2/175

(52) U.S. Cl. 347/87

(57) ABSTRACT

An ink-jet printer including an ink tank and at least one print head having nozzles to spurt out ink supplied from the ink tank and at least two ink inlet in total. The ink tank comprises at least two level tanks arranged in correspondence with the at least two ink inlets and a main tank for recovering excess ink in the respective level tanks and storing the excess ink. The level tanks are piled over the main tank in a tiered manner, and the vertically adjoining level tanks are communicated with each other through the communication passages and the main tank and the level tank of the set ink level being the lowest are communicated with each other through the communication passage. The communication passages each have an upper opening that opens at a level equal to the set ink level in the each level tank, and an ink supply port is provided in the uppermost level tank.

### BACKGROUND OF THE INVENTION

1. Field of the Invention

The present invention relates to an ink-jet printer including ink tanks and print heads with nozzles to spurt out ink supplied from the ink tanks.

2. Description of the Prior Art

An ink-jet printer is generally known using the volume change property of a piezoelectric element, as shown in FIG. 11. The general type of ink-jet printer is provided with ink tanks A and print heads C with nozzles B to spurt out a jet of ink.

The ink tanks A and the print heads C are connected through ink supply-pipes D, through which the ink in the ink tanks A is supplied to their respective print heads C to spurt out a jet of ink from the nozzles B of the print heads C.

The print heads C are equipped therein with piezoelectric elements (not shown) so that ink pressure-chambers can be changed in volume by using the volume change properties of the piezoelectric elements. The piezoelectric elements are varied in volume by application of voltage thereto so as to reduce the volume of the ink pressure-chambers and thereby the pressure of the ink pressure-chambers is increased to spurt out a jet of ink from the nozzles communicating with the ink pressure-chambers.

Further, a vertical level difference is provided between the ink level in the ink tank A and the bottom of the lowermost nozzle of the related print head C so that the ink can be supplied from the ink tank A to the print head C via capillary phenomenon.

For an amount of ink supplied via the capillary phenomenon to be kept constant, it is necessary that the ink level in the ink tank A should always be kept constant.

In order to keep the ink level constant, the conventional ink-jet printer is provided with a liquid level sensor in each ink tank A to detect the lowering of the ink level, so as to supply the ink to the ink tank under control of the liquid level sensor. This disadvantageously requires the provision of an additional ink supply tank for each of the ink tanks A.

Also, a plurality of print heads C, which are used for a print of a large letter or character or image with which only a single print head C cannot cope, and the ink tanks A are arranged in corresponding relation, as shown in FIGS. 11 and 12.

However, when the plurality of ink heads C and the ink tanks A are arranged in corresponding relation, it is required that the ink level in the ink tank A be controlled for each of the print heads C. This requires that the liquid level sensor should be arranged for each of the ink tanks A and also the ink supply tank should be provided for each of the ink tanks A. This involves the disadvantages of an increased number of components and thus increased costs and a complex structure of the printer.

Further, since the ink level must be controlled for each individual ink tank A, there is provided the disadvantage of complicated control of the ink level.

Furthermore, the ink supply ports are normally formed on the top of the ink tanks A in order to supply the ink from the ink supply tanks to the ink tanks A. Due to this, in order to allow the ink supply ports to open, the plurality of ink tanks A are required to be arranged side by side, thus disadvantageously requiring a large space for the ink tanks to be set.

### SUMMARY OF THE INVENTION

It is the object of the present invention to provide an ink-jet printer capable of controlling the ink level in the ink tanks in an easy and simple way with a smallest possible number of components without complicated structure. It is also the object of the present invention to provide an ink-jet printer that can be set in a limited space.

The present invention is directed to a novel ink-jet printer comprising an ink tank and at least one print head having nozzles to spurt out ink supplied from the ink tanks and at least two ink inlets in total, characterized in that the ink tank comprises at least two level tanks arranged in correspondence with the at least two ink inlets and a main tank for recovering excess ink in the respective level tanks and storing the excess ink; the level tanks are connected through communication passages so that ink levels set in the respective level tanks can vary stepwise from tank to tank; the level tank of the set ink level being the highest is provided with an ink supply port; the level tank of the set ink level being the lowest is communicated with the main tank through the communication passage arranged therebetween; and the communication passages each have two openings, one of which opens at a level equal to the set ink level in each level tank and the other of which opens at a level higher than the ink level set in the level tank in which the ink level is set at a level lower than the ink level set in the level tank to which the one opening opens or opens to the main tank, whereby the ink in each level tank can be allowed to flow out to the adjacent level tank or the main tank through the communication passage. This can provide the result that when the quantity of ink in each level tank reaches to the set ink level in the each level tank, the ink can be allowed to flow out therefrom to the sequent level tank of the set ink level being lower than that through the communication passage so as to control the ink level.

Thus, even when the ink is continuously supplied to the respective tanks when the ink-jet printer is at work, the ink supplied beyond the set ink level is allowed to flow out to the sequent tank through the communication passage, so that the amount of ink in the respective level tank is always maintained at the set ink level.

As a result of this, the need to detect the ink level for each of level tanks by use of the sensors can be eliminated and thus a simplified control of the ink level can be achieved.

Further, the need for the ink supply tank to be additionally arranged for each level tank can be eliminated and also the need to arrange the ink level sensor for each level tank can be eliminated. Thus, the number of components and thus the costs can be reduced and also simplification in the entire structure of the inkjet printer can be achieved.

Furthermore, since a plurality of level tanks are piled over the main tank in a tiered manner; the vertically adjoining level tanks are communicated with each other through the communication passages and the main tank and the level tank of the set ink level being the lowest are communicated with each other through the communication passage; and the upper opening of the communication opens at a level equal to the set ink level in the level tank, the ink-jet printer of the present invention can be set in a limited space to save space.

Besides, since the main tank and the ink supply port of the level tank of the set ink level being the highest are connected through the ink supply passage and also the pump is arranged in the ink supply passage to supply the ink in the main tank to the level tanks, the ink is supplied from the main tank to the respective level tanks and also the excess ink is recovered from the level tank of the set ink level being the lowest to the main tank. Thus, the ink can be allowed to circulate between the main tank and the level tanks, thus achieving homogenization of the ink in the main tank and the respective level tanks.

It is preferable that the level tanks are formed by tank cases each opening at the top and having a bottom wall and a side wall, and the side wall is provided, at upper and lower portions thereof, with coupling portions to allow the tank cases to be coupled, so as to define individual level tank chambers when the tank cases are piled. This can provide the advantage that the level tanks can be formed by simply piling the tank cases.

In addition, it is preferable that the tank case having the bottom wall, the side wall and the communication passage is molded into one piece. This can produce the result that the upper opening of the communication passage can surely be set in a level equal to the set ink level in the level case by simply piling the tank cases without any troublesome work of connecting the pipe of the communication passage to the tank case. This can provide the advantage of improved workability.

### BRIEF DESCRIPTION OF THE DRAWINGS

In the drawings:

FIG. 1 is an overview structure diagram of an ink-jet printer in accordance with a first embodiment of the present invention;

FIG. 2 is an illustration of a level tank in accordance with the first embodiment of the present invention;

FIG. 3 is a sectional view showing a level tank in accordance with a second embodiment of the present invention;

FIG. 4 is a top view of the level tank of FIG. 3;

FIG. 5 is an illustration of a structure of a level tank in accordance with a third embodiment of an ink-jet printer of the present invention;

FIG. 6 is an illustration of a structure of a level tank in accordance with a fourth embodiment of an inkjet printer of the present invention;

FIG. 7 is an illustration of a structure of a level tank in accordance with a fifth embodiment of an inkjet printer of the present invention;

FIG. 8 is an illustration of a structure of a level tank in accordance with a sixth embodiment of an ink-jet printer of the present invention;

FIG. 9 is an illustration of a party wall for forming the level tank of the sixth embodiment shown in FIG. 8;

FIG. 10 is an illustration of a structure of a level tank in accordance with a seventh embodiment of an ink-jet printer of the present invention;

FIG. 11 is a perspective view showing a conventional type of ink-jet printer; and

FIG. 12 is an illustration showing a positional relationship between print heads and ink tanks of the conventional ink-jet printers.

### DETAILED DESCRIPTION OF THE PREFERRED EMBODIMENTS

In the following, the present invention will be described in detail by way of illustrative embodiments with reference to the accompanying drawing figures.

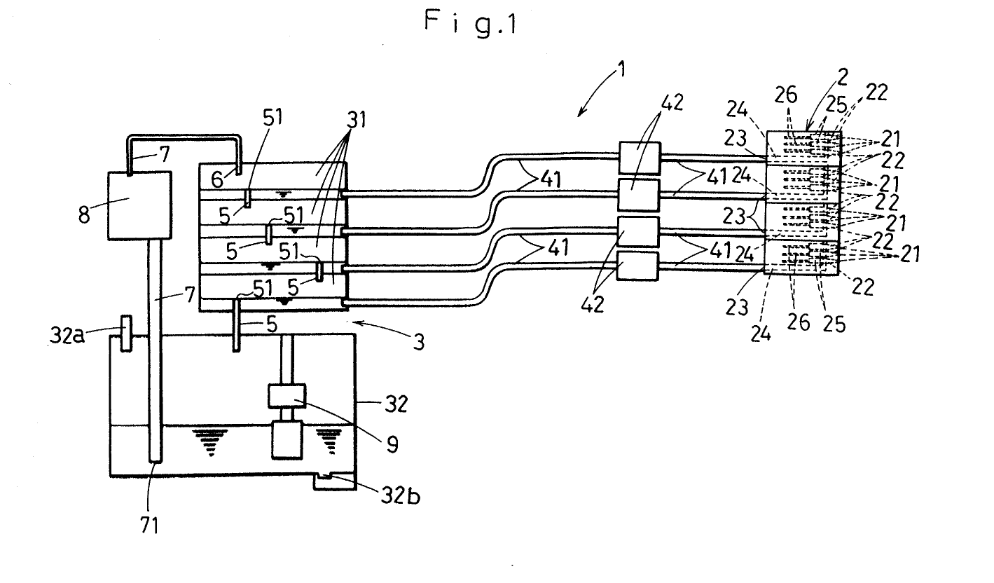

Referring to FIG. 1, there is shown a schematic structural diagram of an ink-jet printer in accordance with one of the embodiments of the present invention. It should be noted that the present invention covers the ink-jet printer 1 using the volume change property of a piezoelectric element, including those that will be illustrated in subsequent embodiments.

The inkjet printer 1 is provided with print heads 2 having a plurality of nozzles 21 to spurt out a jet of ink and ink tanks 3 for supplying ink to the print heads 2.

In the first embodiment, as illustrated in FIG. 1, the ink-jet printer 1 is provided with four print heads 2. The ink tanks 3 comprises four level tanks 31 that are arranged in correspondence with the print heads 2 and one main tank 32 in which excess ink in the level tanks 31 is recovered and stored and from which the ink is supplied to the level tanks 31.

The print heads 2 and the level tanks 31 are connected to each other through ink supply-pipes 41. The ink in the level tanks 31 is supplied to the print heads 2 through the ink supply-pipes 41 and is spurted out from nozzles 21 of the print heads 2. Filters 42 are arranged in the ink supply-pipes 41 in certain places between the print heads 2 and the level tanks 31.

The print heads 2 have ink inlets 23 to be connected with the ink supply-pipes 41, as shown in FIG. 1. The print heads 2 have ink pressure-chambers 22 formed in correspondence with the nozzles 21 to which the nozzles 21 open. Also, the print heads 2 have communication passage 24 formed therein to communicate between the ink inlets 23 and the ink pressure-chambers 22.

Further, the print heads 2 contain pistons 25 that are allowed to move in reciprocation in the ink pressure-chambers 22. Piezoelectric elements 26 that are varied in volume by application of voltage thereto are connected to the pistons 25. In use, the piezoelectric elements 26 are brought into the charged state so as to be contracted, first. The pistons 25 are then pulled back to increase the volume of the ink pressure-chambers 22 and suck the ink into the ink pressure-chambers 22 from the ink supply-pipes 41 through the communication passages 24. Then, the piezoelectric elements 26 are brought into the discharged state from the charged state and thereby they are returned to the original state from the contracted state. This carries the pistons 25 forward, so that the volume of the ink pressure-chambers 22 is reduced and the pressure thereof is increased to spurt out the ink from the nozzles 21.

Further, the print heads 2 and the level tanks 31 are arranged so that the bottom of the lowermost nozzle 21 provided in each print head 2 can be higher in level than an ink level set in the related level tank 31 to supply the ink from the level tanks 31 to the print heads 2, as shown in FIG. 1. With this arrangement, the ink is supplied from the level tanks 31 to the print heads 2 via capillary phenomenon resulting from the level difference between the ink level in each level tank 31 and the bottom of the lowermost nozzle 21 in each print head 2.

In the first embodiment, two or more level tanks 31 are vertically piled in a tiered manner and the level tanks 31 thus piled are placed over the main tank 32.

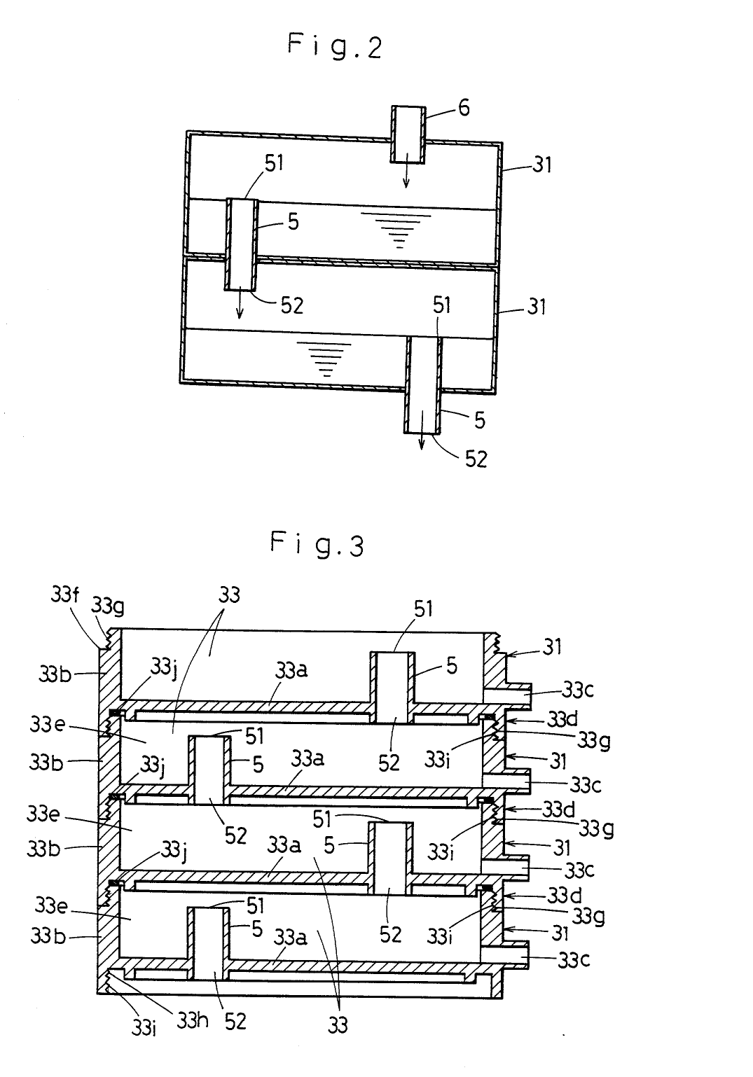

As shown in FIG. 2, the vertically piled level tanks 31 are made to communicate with each other in the interior thereof via the communication passages 5 formed by pipes and the like.

Each communication passage 5 is arranged to extend through a bottom of an upper level tank 31 and a top of a lower level tank 31. The communication passage 5 has an upper opening 51 opening at a level equal to the set ink level in the level tank 31 and a lower opening 52 opening at a level higher than the set ink level in the level tank 31. Also, ink supply-pipe 41 connected to the level tank 31 opens in the level tank 31 at a level lower than the set ink level in the level tank 31.

Further, the lowermost level tank 31 and the main tank 32 are communicated with each other through the communication passage 5 connecting between the bottom of the lowermost level tank 31 and the top of the main tank 32. In addition, the communication passage 5 opening in the lowermost level tank 31 has an upper opening 51 opening at a level equal to the set ink level in the lowermost level tank 31 and a lower opening 52 opening at an upper portion of the main tank 32.

The uppermost level tank 31 is provided, at a top thereof, with an ink supply port 6, from which the ink in the main tank 32 is supplied to the uppermost level tank through an ink supply passage 7.

The ink supply passage 7 is connected between the main tank 32 and the ink supply port 6 of the uppermost level tank 31. A pump 8 for supplying the ink in the main tank 32 to the level tanks 31 is arranged in the ink supply passage 7 in a certain place between the main tank 32 and the uppermost level tank 31.

The ink supply passage 7 has an opening 71 opening in the main tank 32 at a level near the bottom thereof. Further, the main tank 32 is provided, at a top thereof, with an ink refilling port 32a for refilling the ink into the main tank 32 and is provided, at a bottom thereof, with a drain 32b for draining the ink in the main tank 32.

Further, the main tank 32 is provided therein with an ink level sensor 9 for detecting an amount of ink in the main tank 32. When the ink level is lowered beyond the set ink level in the main tank, an operator is warned to that effect or the ink is automatically refilled in the main tank from the ink refilling port 32a under control of the ink level sensor 9.

With the ink-jet printer 1 thus constructed, the ink in the main tank 32 is supplied from the ink supply port 6 to the uppermost level tank 31 through the ink supply passage 7 by the drive of the pump 8.

After the ink supplied in the uppermost level tank 31 is stored to the set ink level, the excess ink flows out therefrom through the communication passage 5 opening at the level equal to the set ink level and is fed into the sequent level tank 31 right under the uppermost level tank.

Further, the same operation is performed in the sequent level tank 31, so that the excess ink flows out therefrom through the communication passage 5 and is fed into the sequent level tank 31.

After the ink supplied to the lowermost level tank 31 is stored to the set ink level in the lowermost level tank 31, the excess ink flows out therefrom through the communication passage 5 and is recovered in the main tank 32.

In the ink-jet printer 1 of the embodiment, when the ink-jet printer 1 is at work, the ink in the main tank 32 is continuously supplied to the respective level tanks 31. Even when the ink is continuously supplied to the respective tanks, the ink supplied beyond the set ink level is allowed to flow out to the sequent tank through the communication passage 5, so that an amount of ink in the respective level tank 31 can always be maintained at the set ink level.

The ink in the level tanks 31 is supplied to the print heads 2 through the ink supply-pipes 41, so that the ink in the main tank 32 is gradually decreased while it is circulated through the respective level tanks 31. When the lowering of the ink level is detected by the liquid level sensor 9 provided in the main tank 32, the ink is refilled in the main tank 32 from the ink refilling port 32a until the ink reach the set ink level.

As seen from the foregoing, according to the present invention, the ink-jet printer 1 is structured so that when the ink in each level tank 31 reaches the set ink level, the ink can be allowed to flows out therefrom through the communication passage 5 to be sequentially supplied downstream into the sequent level tanks 31, so as to control the ink level in the each level tank. This can eliminate the need to detect the ink level for each of level tank 31 by use of the sensors and thus can achieve a simplified control of the ink level.

Further, since the ink is supplied from the main tank 32 to the uppermost level tank 31 and then is sequentially supplied downstream therefrom to the sequent level tanks and the excess ink is recovered by the main tank provided under the lowermost level tank, the need for the ink supply tank to be additionally arranged for each level tank 31 can be eliminated and also the need to arrange the ink level sensor for each level tank 31 can be eliminated. This can produce reduction in number of components and thus in costs and also can achieve simplification in the entire structure of the ink-jet printer.

Furthermore, since a plurality of level tanks 31 are vertically piled in a tiered manner and the level tanks 31 thus piled are placed over the main tank 32, the ink-jet printer of the present invention can be set in a limited space to save space.

Besides, since the main tank 32 and the ink supply port 6 of the uppermost level tank 31 are connected through the ink supply passage 7 and also the pump 8 is arranged in the ink supply passage 7 in a certain place therebetween to supply the ink in the main tank 32 to the level tanks 31, the ink is supplied from the main tank 32 to the respective level tanks 31 and also the excess ink is recovered from the lowermost level tank 31 to the main tank 32. Thus, the ink can be allowed to circulate between the main tank 32 and the level tanks 31, thus achieving homogenization of the ink in the main tank 32 and the respective level tanks 31.

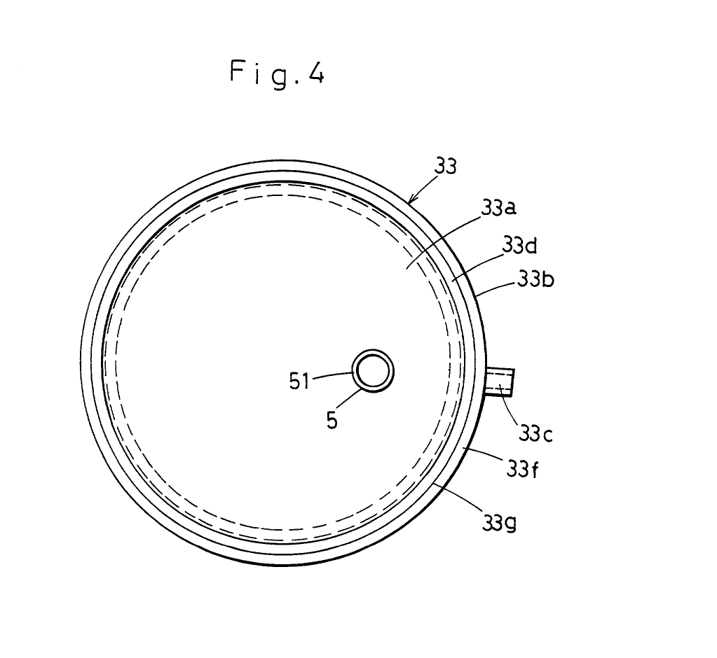

Referring now to FIGS. 3 and 4, the second embodiment of the present invention will be described which is an alternation of the arrangement of the level tanks 31. In the alternation, tank cases 33 each having a bottom wall 33a, a side wall 33b and an ink discharge port 33c to which the ink supply-pipe 41 is connected and having an opening at the top are molded by an injection molding, as shown in FIG. 3. Further, the side wall 33b of the tank case 33 may is provided, at its upper and lower portions, with coupling portions 33d to allow the tank cases 33 to be coupled, so as to define individual level tank chambers 33e when the tank cases are vertically piled.

Each coupling portion 33d comprises an upper step portion 33f formed by cutting out an upper end portion of the side wall 33b at an outside thereof, an external thread portion 33g formed at the upper step portion 33f, a lower step portion 33h formed by cutting out a lower end portion of the side wall 33b at an inside thereof, and an internal thread portion 33i formed at the lower step portion 33h. The upper and lower tank cases 33 are coupled together in airtight relation by threaded engagement between the external thread portion 33g and the internal thread portion 33i. In order to provide an increased airtight chamber, a packing member 33j is interposed between the bottom 33a of an upper tank case 33 and the top of the side wall 33b of a lower tank case 33.

Two different types of tank cases 33 are molded which are different from each other in the location where the communication passage 5 is formed, and those different types of tank cases 33 are piled alternately so as to form the level tanks 31. The communication passages 5 are displaced from each other so as not to be in alignment with each other when the tank cases 33 are plied, as shown in FIG. 3. This is because if the communication passages 5 are put in alignment with each other when the tank cases 33 are piled, the ink will flow from the upper communication passage 5 directly to the lower communication passage 5.

With this arrangement of the second embodiment using the tank cases 33 each having the opening at the top which are formed by the injection molding, there is provided the advantage that the level tanks 31 can be formed by simply piling the tank cases 33.

Further, the tank cases 33 are preferably formed by molding the bottom wall 33a, the side wall 33b and the communication passage 5 in one piece, as shown in FIGS. 3 and 4.

With this arrangement of the communication passage 5 being integrally formed in the tank case 33, the upper opening 51 of the communication passage 5 can surely be set in a level equal to the set ink level in the level case 31 by simply piling the tank cases 33 without any troublesome work of connecting the pipe of the communication passage 5 to the tank case 33. This can provide the advantage of improved workability.

It should be noted that while in the first embodiment, the ink-jet printer 1 has the four print heads 2 each having the single ink inlet, as shown in FIG. 1, the present invention can be applied to the alternation of a single print head with a plurality of ink inlets. In this alternation using the single print head with the plurality of ink inlets, the level tanks are provided respectively one for each ink inlet, and the ink level in the each level tank is controlled by the present invention.

In the following, other embodiments will be described of the present invention that is characterized in that the level tanks are connected through the communication passages so that the ink levels set in the level tanks can vary stepwise from tank to tank; the level tank of the set ink level being the lowest is communicated with the main tank through the communication passage arranged therebetween; and each communication passage has two openings, one of which opens at a level equal to the set ink level in each level tank and the other of which opens at a level higher than the ink level set in the level tank in which the ink level is set at a level lower than the ink level set in the level tank to which the one opening opens or to the main tank, so that the ink in each level tank can flow out to the adjacent level tank or the main tank through the communication passage. The difference between the first and second embodiments already mentioned and the other embodiments as will be mentioned later is in the arrangement of the level tanks and communicating passages, as will become appararent upon a reading of the following description.

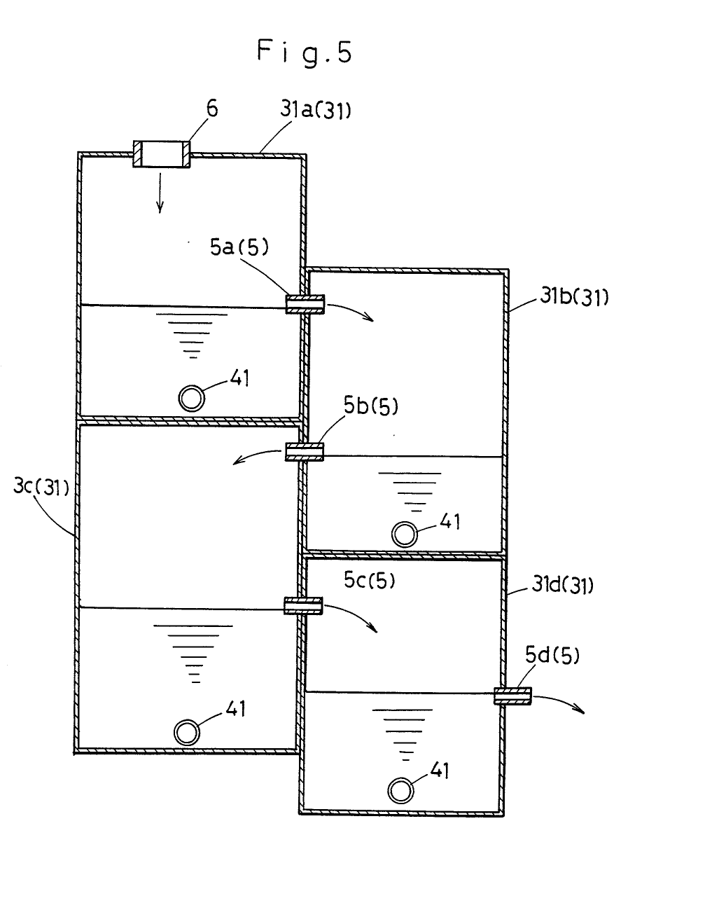

Referring to FIG. 5 in which there is shown the third embodiment, the level tanks 31 piled are arranged in two rows and also are displaced stepwise from each other in a vertical direction, as shown in FIG. 5.

The laterally adjoining level tanks 31 are communicated through the communication passages 5 of the pipes opening thereto. To be more specific, the first level tank 31a disposed at an uppermost level and the second level tank 31b disposed at the lateral side thereof are communicated with each other through the first communication passage 5a. The second level tank 31b and the third level tank 31c disposed under the first level tank 31a are communicated with each other through the second communication passage 5b. The third level tank 31c and the fourth level tank 31d disposed under the second level tank 31b are communicated with each other through the third communication passage 5c. The fourth level tank 31d is communicated with the main tank through the fourth communication passage 5d.

The first communication passage 5a is disposed so as to open at a level corresponding to the set ink level in the first level tank 31a. The second communication passage 5b is disposed so as to open at a level corresponding to the set ink level in the second level tank 31b. The third communication passage 5c is disposed so as to open at a level corresponding to the set ink level in the third level tank 31c. The fourth communication passage 5d is disposed so as to open at a level corresponding to the set ink level in the fourth level tank 31d.

Reference numeral 6 designates an ink supply port provided at the top of the first level tank 31a, and reference numeral 41 designates ink supply-pipes for supplying the ink to the print heads.

With this arrangement of the third embodiment, when the ink is supplied to the first level tank 31a from the ink supply port 6 at the top thereof, the excess ink flows out sequentially through the communication passages 5, as indicated by arrows in FIG. 5, so that the ink levels in the respective level tanks 31 can be controlled so as to be kept constant.

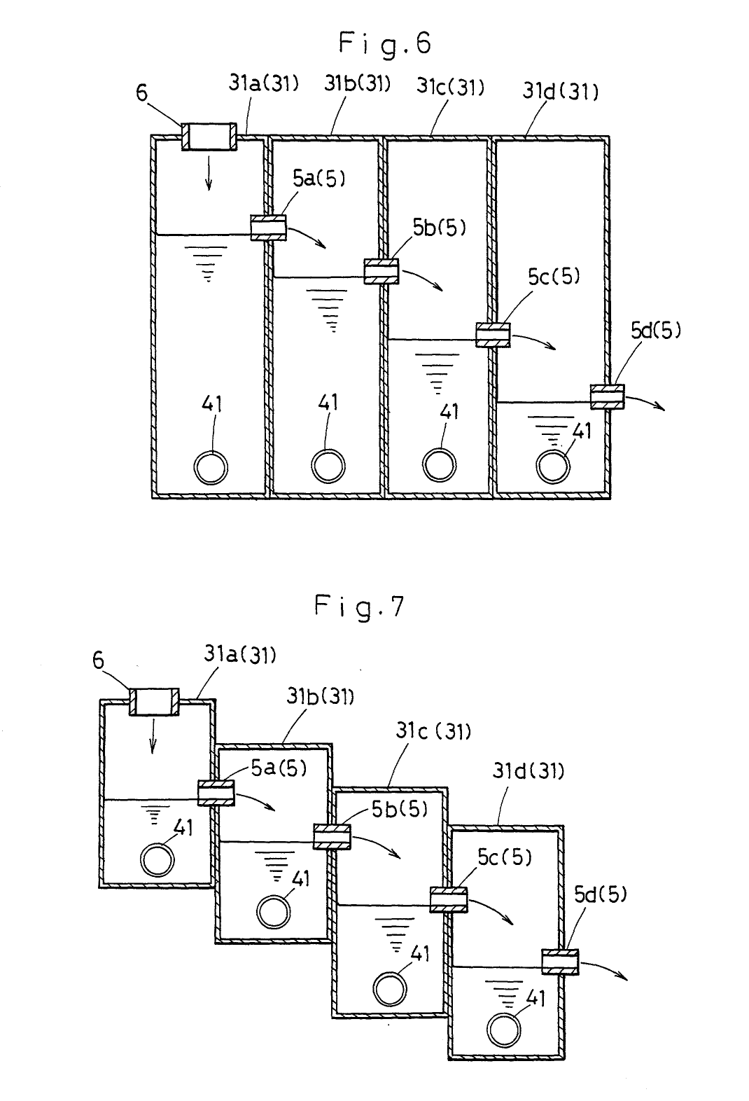

Referring now to FIG. 6 in which there is shown the fourth embodiment, the level tanks 31 shown in FIG. 6, which are all of equal size, are disposed side by side so that they come level with each other. Also, the communication passages 5 are made to open to the laterally adjoining level tanks 31 and are arranged so that the set ink levels in the laterally adjoining level tanks 31 can become gradually lower from left to right when viewed in FIG. 6.

Specifically, the first level tank 31a at the left end and the second level tank 31b disposed at the lateral side thereof are communicated through the first communication passage 5a. The second level tank 31b and the third level tank 31c disposed at the lateral side thereof are communicated through the second communication passage 5b. The third level tank 31c and the fourth level tank 31d disposed at the lateral side thereof are communicated through the third communication passage 5c. The fourth level tank 31d is communicated with the main tank through the fourth passage 5d.

The first communication passage 5a is disposed so as to open at a level corresponding to the set ink level in the first level tank 31a. The second communication passage 5b is disposed so as to open at a level corresponding to the set ink level in the second level tank 31b. The third communication passage 5c is disposed so as to open at a level corresponding to the set ink level in the third level tank 31c. The fourth communication passage 5d is disposed so as to open at a level corresponding to the set ink level in the fourth level tank 31d.

Reference numeral 6 designates the ink supply port provided at the top of the first level tank 31a, and reference numeral 41 designates ink supply-pipes for supplying the ink to the print heads.

With this arrangement of the fourth embodiment, when the ink is supplied to the first level tank 31a from the ink supply port 6 at the top thereof, the excess ink flows out sequentially through the communication passages 5, as indicated by arrows in FIG. 6, so that the ink levels in the respective level tanks 31 can be controlled so as to be kept constant.

Referring to FIG. 7 in which there is shown the fifth embodiment, the level tanks 31 shown in FIG. 7, which are all of equal size, are disposed side by side so that they gradually become lower in level from left to right when viewed in FIG. 7. Also, the communication passages 5 of the pipes are made to open to the laterally adjoining level tanks 31 and are arranged so that the set ink levels in the laterally adjoining level tanks 31 can become gradually lower from left to right when viewed in FIG. 7.

Specifically, the first level tank 31a at the left end and the second level tank 31b disposed at the lateral side thereof are communicated through the first communication passage 5a. The second level tank 31b and the third level tank 31c disposed at the lateral side thereof are communicated through the second communication passage 5b. The third level tank 31c and the fourth level tank 31d disposed at the lateral side thereof are communicated through the third communication passage 5c. The fourth level tank 31d is communicated with the main tank through the fourth passage 5d.

The first communication passage 5a is disposed so as to open at a level corresponding to the set ink level in the first level tank 31a. The second communication passage 5b is disposed so as to open at a level corresponding to the set ink level in the second level tank 31b. The third communication passage 5c is disposed so as to open at a level corresponding to the set ink level in the third level tank 31c. The fourth communication passage 5d is disposed so as to open at a level corresponding to the set ink level in the fourth level tank 31d.

Reference numeral 6 designates the ink supply port provided at the top of the first level tank 31a, and reference numeral 41 designates ink supply-pipes for supplying the ink to the print heads.

With this arrangement of the fifth embodiment, when the ink is supplied to the first level tank 31a from the ink supply port 6 at the top thereof, the excess ink flows out sequentially through the communication passages 5, as indicated by arrows in FIG. 7, so that the ink levels in the respective level tanks 31 can be controlled so as to be kept constant.

In the fourth embodiment shown in FIG. 6, a maximum amount of ink is stored to the set ink level in the first level tank 31a and the amount of ink stored in the respective level tanks is gradually decreased downstream therefrom. In contrast to this, in the fifth embodiment of FIG. 7, since the level tanks 31 themselves are displaced vertically stepwise from each other, so that the same amount of ink can be stored in all the level tanks 31.

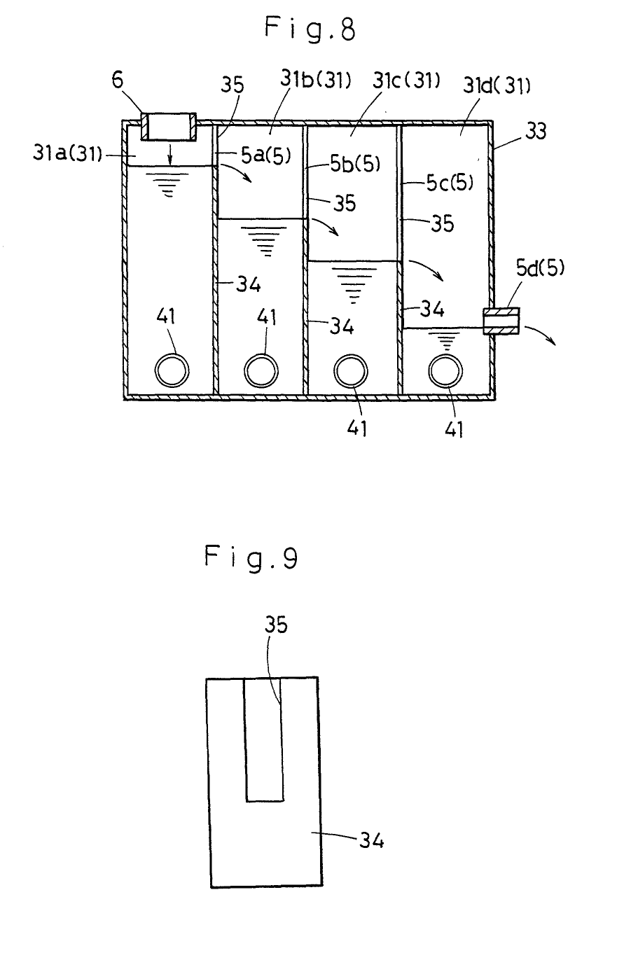

Referring now to FIG. 8 in which there is shown the sixth embodiment, the level tank 31 shown in FIG. 8 is a combination of a plurality of level tanks 31 in one. The plurality of level tanks 31 are formed by partitioning a large tank case 33 by use of partition walls 34. The level tanks 31 are disposed side by side. Also, the communication passages 5 are made to open to the laterally adjoining level tanks 31 and are arranged so that the set ink levels in the laterally adjoining level tanks 31 can become gradually lower from left to right when viewed in FIG. 8.

Specifically, the first level tank 31a at the left end and the second level tank 31b disposed at the lateral side thereof are communicated through the first communication passage 5a. The second level tank 31b and the third level tank 31c disposed at the lateral side thereof are communicated through the second communication passage 5b. The third level tank 31c and the fourth level tank 31d disposed at the lateral side thereof are communicated through the third communication passage 5c. The fourth level tank 31d is communicated with the main tank through the fourth passage 5d.

The first communication passage 5a, the second communication passage 5b and the third communication passage 5c are formed by cutout portions 35 formed in the partition walls 34, respectively, as shown in FIG. 9. The fourth communication passage 5 is formed by a pipe.

Further, the first communication passage 5a is provided so as to open at a level corresponding to the set ink level in the first level tank 31a. The second communication passage 5b is disposed so as to open at a level corresponding to the set ink level in the second level tank 31b. The third communication passage 5c is disposed so as to open at a level corresponding to the set ink level in the third level tank 31c. The fourth communication passage 5d is disposed so as to open at a level corresponding to the set ink level in the fourth level tank 31d.

Reference numeral 6 designates the ink supply port provided at the top of the first level tank 31a, and reference numeral 41 designates ink supply-pipes for supplying the ink to the print heads.

With this arrangement of the sixth embodiment, when the ink is supplied to the first level tank 31a from the ink supply port 6 at the top thereof, the excess ink flows out sequentially through the communication passages 5, as indicated by arrows in FIG. 8, so that the ink levels in the respective level tanks 31 can be controlled so as to be kept constant.

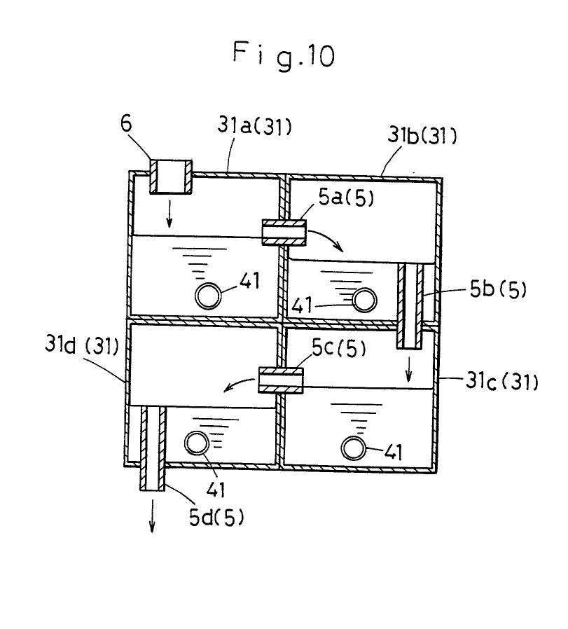

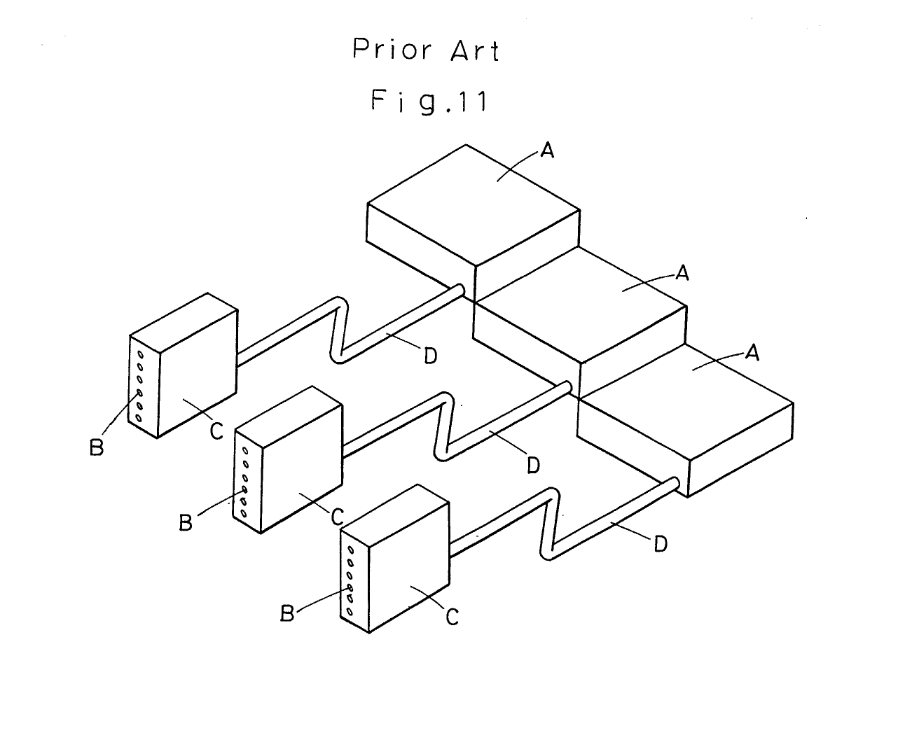

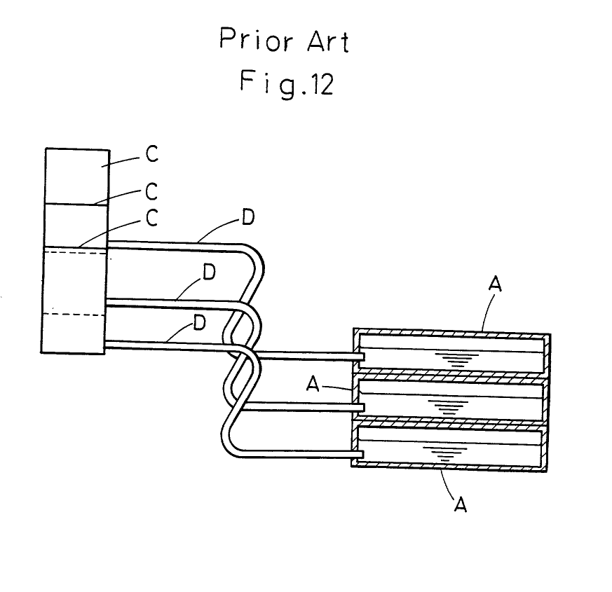

Referring to FIG. 10 in which there is shown the seventh embodiment, the level tanks 31 piled are arranged in two rows and also the laterally adjoining level tanks 31 are arranged to be on a level with each other in a vertical direction, as shown in FIG. 10.

The laterally adjoining level tanks 31 are communicated through the communication passages 5 of the pipes opening thereto. To be more specific, the first level tank 31a of an uppermost ink level and the second level tank 31b disposed at the lateral side thereof are communicated with each other through the first communication passage 5a. The second level tank 31b and the third level tank 31c disposed under the second level tank 31b are communicated with each other through the second communication passage 5b. The third level tank 31c and the fourth level tank 31d disposed under the first level tank 31a are communicated with each other through the third communication passage 5c. The fourth level tank 31d is communicated with the main tank through the fourth communication passage 5d.

The first communication passage 5a is disposed horizontally so as to open at a level corresponding to the set ink level in the first level tank 31a. The second communication passage 5b is disposed vertically so as to open at a level equal to the set ink level in the second level tank 31b. The third communication passage 5c is disposed horizontally so as to open at a level corresponding to the set ink level in the third level tank 31c. The fourth communication passage 5d is disposed vertically so as to open at a level equal to the set ink level in the fourth level tank 31d.

Reference numeral 6 designates the ink supply port provided at the top of the first level tank 31a, and reference numeral 41 designates ink supply-pipes for supplying the ink to the print heads.

With this arrangement of the seventh embodiment, when the ink is supplied to the first level tank 31a from the ink supply port 6 at the top thereof, the excess ink flows out sequentially through the communication passages 5, as indicated by arrows in FIG. 10, so that the ink levels in the respective level tanks 31 can be controlled so as to be kept constant.

While there has been described preferred forms of the present invention, such are for illustrative purpose only. Modification and variation of the present invention that will be obvious to those skilled in the art is to be covered by the following claims.

What is claimed is:

1. An ink-jet printer comprising an ink tank and at least one print head having nozzles to spurt out ink supplied from the ink tanks and at least two ink inlets in total, characterized in that the ink tank comprises at least two level tanks arranged in correspondence with the at least two ink inlets and a main tank for recovering excess ink in the respective level tanks and storing the excess ink; the level tanks are connected through communication passages so that ink levels set in the respective level tanks can vary stepwise from tank to tank; the level tank of the set ink level being the highest is provided with an ink supply port; the level tank of the set ink level being the lowest is communicated with the main tank through the communication passage arranged therebetween; and the communication passages each have two openings, one of which opens at a level equal to the set ink level in each level tank and the other of which opens at a level higher than the ink level set in the level tank in which the ink level is set at a level lower than the ink level set in the level tank to which the one opening opens or opens to the main tank, whereby the ink in each level tank can be allowed to flow out to the adjacent level tank or the main tank through the communication passage.

2. The ink-jet printer according to claim 1, wherein the plurality of level tanks are piled over the main tank in a tiered manner; the vertically adjoining level tanks are communicated with each other through the communication passages and the main tank and the level tank of the set ink level being the lowest are communicated with each other through the communication passage; and the communication passages each have an upper opening that opens at a level equal to the set ink level in the each level tank.

3. The ink-jet printer according to claim 1, wherein the main tank and the ink supply port of the level tank of the set ink level being the highest are connected with each other through an ink supply passage, and a pump for supplying the ink in the main tank to the level tanks is arranged in the ink supply passage.

4. The ink-jet printer according to claim 2, wherein the main tank and the ink supply port of the level tank of the set ink level being the highest are connected with each other through an ink supply passage, and a pump for supplying the ink in the main tank to the level tanks is arranged in the ink supply passage.

5. The ink-jet printer according to claim 2, wherein the level tanks are formed by tank cases each opening at the top and having a bottom wall and a side wall, and the side wall is provided, at upper and lower portions thereof, with coupling portions to allow the tank cases to be coupled, so as to define individual level tank chambers when the tank cases are piled.

6. The inkjet printer according to claim 3, wherein the level tanks are formed by tank cases each opening at the top and having a bottom wall and a side wall, and the side wall is provided, at upper and lower portions thereof, with coupling portions to allow the tank cases to be coupled, so as to define individual level tank chambers when the tank cases are piled.

7. The inkjet printer according to claim 4, wherein the level tanks are formed by tank cases each opening at the top and having a bottom wall and a side wall, and the side wall is provided, at upper and lower portions thereof, with coupling portions to allow the tank cases to be coupled, so as to define individual level tank chambers when the tank cases are piled.

8. The ink-jet printer according to claim 5, wherein the tank case having the bottom wall, the side wall and the communication passage is molded into one piece.

9. The ink-jet printer according to claim 6, wherein the tank case having the bottom wall, the side wall and the communication passage is molded into one piece.

10. The ink-jet printer according to claim 7, wherein the tank case having the bottom wall, the side wall and the communication passage is molded into one piece.
